(19) United States
(12) Patent Application Publication
(10) Pub. No.: US 2024/0213608 A1
(43) Pub. Date: Jun. 27, 2024

(54) BATTERY CARRYING TRAY

(71) Applicant: HANIL HIGHTECH CO., LTD., Hwaseong-si (KR)

(72) Inventor: Young Hoon KIM, Osan-si (KR)

(73) Assignee: HANIL HIGHTECH CO., LTD., Hwaseong-si (KR)

(21) Appl. No.: 18/540,132

(22) Filed: Dec. 14, 2023

(30) Foreign Application Priority Data
Dec. 26, 2022 (KR) 10-2022-0183996

(51) Int. Cl. H01M 50/244; H01M 10/6551; H01M 50/211

(52) U.S. Cl. CPC H01M 50/244; H01M 10/6551; H01M 50/211

(57) ABSTRACT

A battery carrying tray includes an outer peripheral frame, and a plurality of inserts having a plurality of slots into which battery leads are inserted and supported, the plurality of inserts being detachably coupled to the outer peripheral frame. A tapered portion is provided on a bottom surface of the outer peripheral frame and shaped to become thinner outward from a center of the bottom surface of the outer peripheral frame.

### CROSS-REFERENCE TO RELATED APPLICATION

This application claims priority to Korean Patent Application No. 10-2022-0183996 (filed on Dec. 26, 2022), which is hereby incorporated by reference in its entirety.

### BACKGROUND

The present disclosure relates to a battery carrying tray, and more particularly, to a battery carrying tray used to carry batteries between processes in a production line or deliver the batteries as finished products. In particular, a battery to which the tray is applied means a pouch cell secondary battery.

Recently, pouch cell secondary batteries have been widely used for various products including IT products such as smartphones, notebook computers, tablet PCs, and auxiliary batteries, hybrid electric vehicles, or energy storage systems (ESSs). The pouch cell secondary battery generates electricity by moving lithium ions between a positive electrode and a negative electrode.

In the related art, in the production line for producing pouch cell secondary batteries, a battery carrying tray is used as a means for safely accommodating and carrying the batteries at the time of conveying the batteries between processes or delivering the batteries as finished products. The battery carrying tray may accommodate a large number of thin batteries in an upright state.

Meanwhile, the pouch cell secondary battery includes cells configured to store electric power, a pouch configured to surround the cells, and leads used to charge or discharge the cells. The pouch cell secondary battery is significantly vulnerable structurally to external impact or heat, but the battery carrying tray in the related art is not sufficiently designed structurally to prevent or reduce the vulnerability.

FIGS. 1A-2B are exemplified views for explaining problems with the battery carrying tray in the related art. For example, in case that a battery carrying tray 30′ is conveyed by a roller conveyor 40 for an automation process in a battery production line, the battery carrying tray 30′ is inclined in proportion to a height deviation in a conveyance direction of rollers during a process in which the battery carrying tray 30′ enters the front roller disposed at a front side based on the conveyance direction, which increases vibration and noise between a bottom edge of the battery carrying tray 30′ and the front roller. Furthermore, even though the natural height deviation in the conveyance direction of the rollers is initially normal, the above-mentioned problem occurs because the height deviation deviates from an allowable range as a load increases. In addition, heat, which is generated during a process such as a battery manufacturing process and a process of charging or discharging the battery, remains in the battery carrying tray 30′ and adversely affects not only the process efficiency for the battery 10 but also yields and performance. In particular, this situation becomes severe in case that the battery carrying trays 30′ are vertically stacked and operated.

### SUMMARY

An object to be achieved by the present disclosure is to provide a battery carrying tray capable of advantageously improving product yields, performance, process efficiency, and working environments by reducing vibration, noise, and residual heat generated during an operation.

The subject matters of the present disclosure, which are considered on the basis of recognition of the technical objects and identical to the features disclosed in claims, are as follows.

(1) A battery carrying tray including: an outer peripheral frame; and a plurality of inserts having a plurality of slots into which battery leads are inserted and supported, the plurality of inserts being detachably coupled to the outer peripheral frame, in which a tapered portion is provided on a bottom surface of the outer peripheral frame and shaped to become thinner outward from a center of the bottom surface of the outer peripheral frame.

(2) The battery carrying tray of (1), in which the tapered portion is configured as a first tapered portion having an inclination direction parallel to a conveyance direction of an external roller conveyor.

(3) The battery carrying tray of (2), in which the tapered portion further includes a second tapered portion having an inclination direction perpendicular to the first tapered portion.

(4) The battery carrying tray of (1), in which a plurality of heat dissipation ports is provided in sidewalls of the outer peripheral frame and configured to allow the inside and outside of the sidewalls to communicate with each other.

(5) The battery carrying tray of (4), in which the heat dissipation port is formed at an uppermost end of each of the sidewalls and communicates with a space disposed above a battery accommodated in the battery carrying tray.

According to the present disclosure described above, the tapered portions formed in the bottom surface of the lateral sides may minimize vibration or noise caused by the collision between the roller and the bottom surface of the battery carrying tray during the conveyance process regardless of the presence or absence of the height deviation in the conveyance direction of the conveyor. In addition, the plurality of heat dissipation ports formed at the uppermost ends of the sidewalls of the battery carrying tray minimizes the amount of heat remaining in the battery carrying tray. Therefore, it is possible to remarkably improve product yields, performance, process efficiency, and working environments.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A, 1B, 2A, and 2B are views for explaining problems with a battery carrying tray in the related art;

FIG. 3 is a perspective view of an outer peripheral frame of a battery carrying tray according to an embodiment of the present disclosure;

FIGS. 4, 5, and 6 are a front view, a side view, and a partially enlarged side view of FIG. 3;

FIG. 7 is a view for explaining a state in which the battery carrying tray according to the embodiment of the present disclosure is moved;

FIGS. 8A and 8B are bottom perspective views of the outer peripheral frame of the battery carrying tray according to the embodiments of the present disclosure; and

FIGS. 9A and 9B are a perspective view and a partially cut-away perspective view, which illustrate a state in which the battery carrying trays according to the embodiment of the present disclosure are stacked.

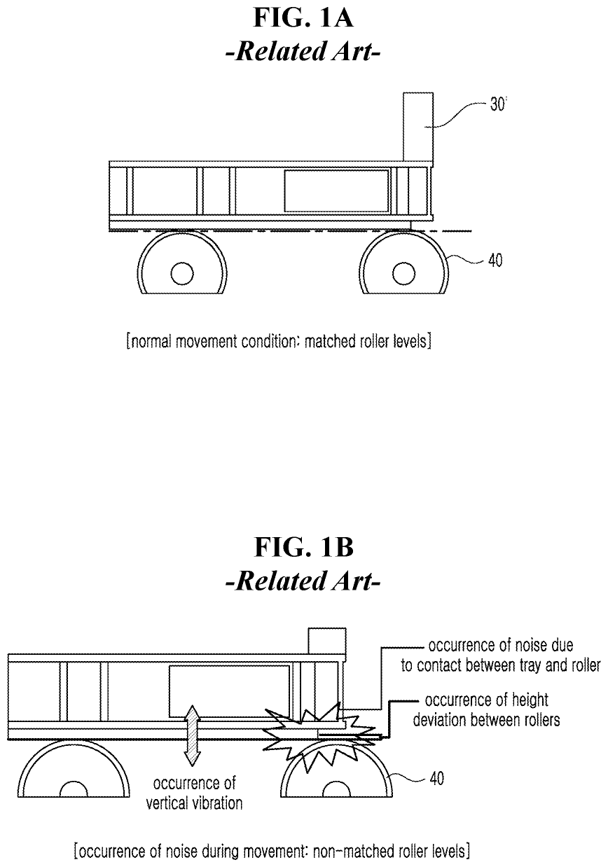

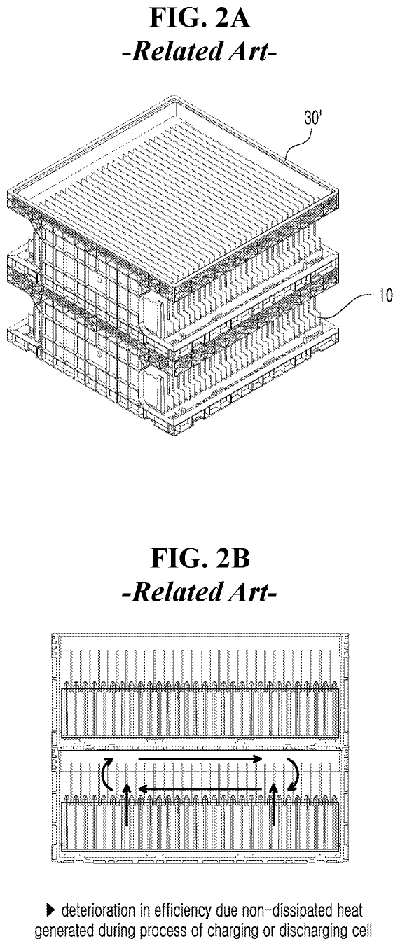

### DETAILED DESCRIPTION

Hereinafter, the present disclosure will be described in detail with reference to the embodiments. In addition, terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method. Therefore, the configurations of the exemplary embodiments disclosed in the present specification are just the best preferred exemplary embodiments of the present disclosure and do not represent all the technical spirit of the present disclosure. Accordingly, it should be appreciated that various equivalents and modified examples capable of substituting the exemplary embodiments may be made at the time of filing the present application. Meanwhile, the same or similar constituent elements and the equivalents thereof will be designated by the same or similar reference numerals. Further, throughout the specification of the present application, unless explicitly described to the contrary, the word “comprise” or “include” and variations, such as “comprises”, “comprising”, “includes” or “including”, will be understood to imply the inclusion of stated constituent elements, not the exclusion of any other constituent elements.

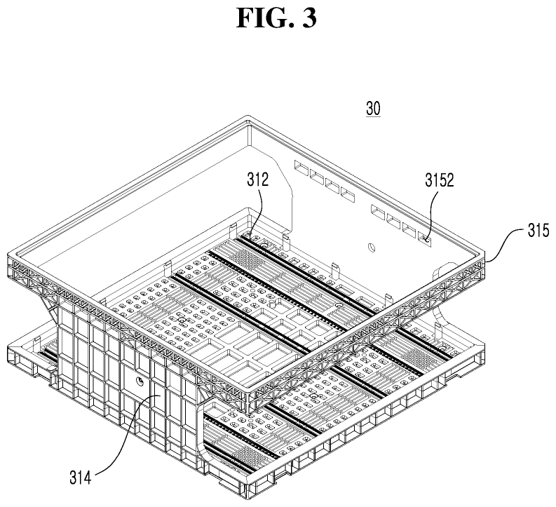

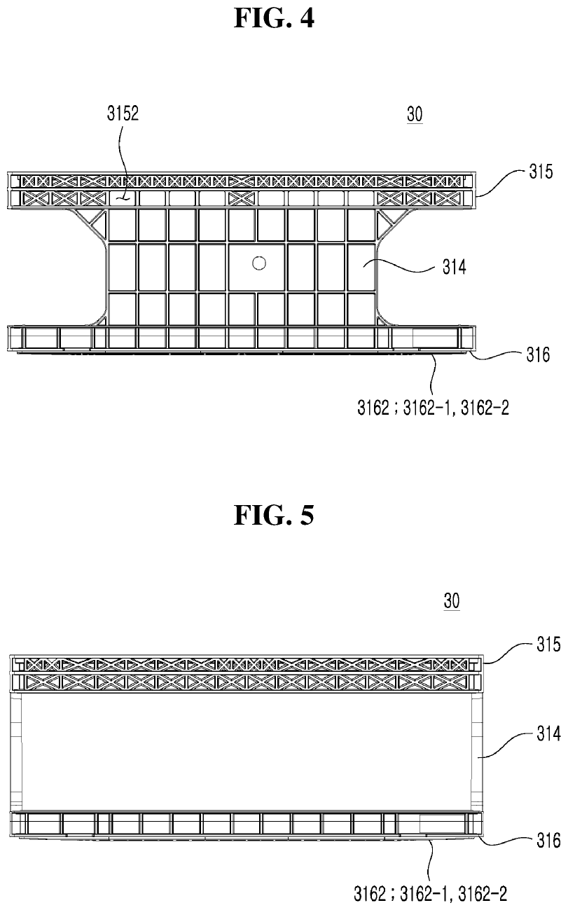

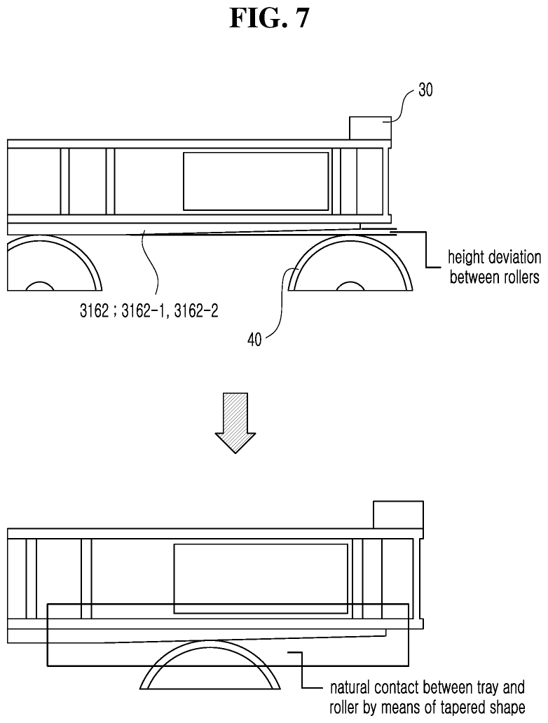

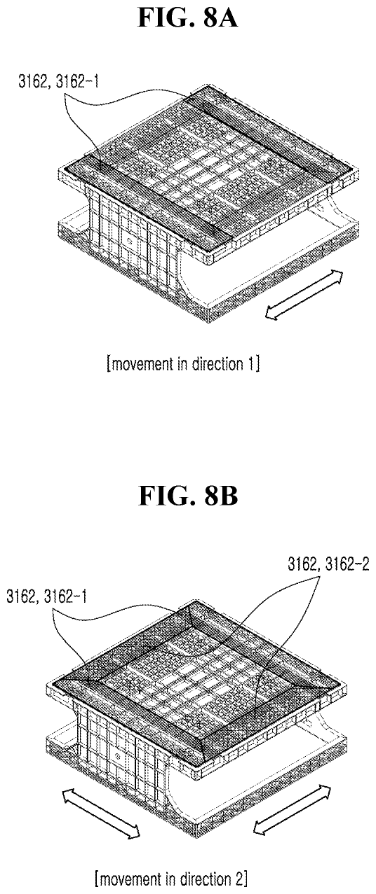

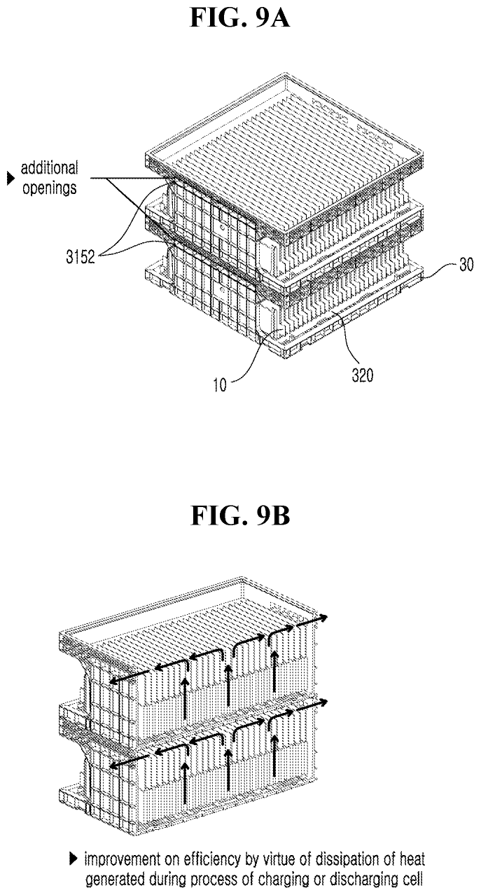

FIG. 3 is a perspective view of an outer peripheral frame 310 of a battery carrying tray 30 (hereinafter, simply referred to as a ‘tray 30’) according to an embodiment of the present disclosure. FIGS. 4, 5, and 6 are a front view, a side view 314, and a partially enlarged side view 314 of FIG. 3. FIG. 7 is a view for explaining a state in which the battery carrying tray 30 according to the embodiment of the present disclosure is moved, FIGS. 8A and 8B are bottom perspective views of the outer peripheral frame 310 of the battery carrying tray 30 according to the embodiments of the present disclosure, and FIGS. 9A and 9B are a perspective view and a partially cut-away perspective view, which illustrate a state in which the battery carrying trays 30 according to the embodiment of the present disclosure are stacked.

A pair of inserts 320 is provided on the outer peripheral frame 310 that constitutes a main body of the tray 30, and the pair of inserts 320 is configured to accommodate and hold a battery 10 (see FIGS. 9A and 9B). The pair of inserts 320 is slidably fixed, by means of a fastening member (not illustrated in the drawings), to guide rails 312 provided on a bottom surface of the outer peripheral frame 310. In FIGS. 3 to 6, the insert 320 is omitted, and only the outer peripheral frame 310 related to the features of the present disclosure is illustrated.

With reference to FIGS. 3 to 5, the outer peripheral frame 310 is made of hard plastic resin and spatially divides a region in which the battery 10 is mounted. The outer peripheral frame 310 has a structure in which a part of an upper side and a part of a lateral side 314 are opened. In the embodiment, front and rear sides 314 are approximately closed, and left and right sides are opened. Meanwhile, an upper end rim 315 is provided to make it easy to handle the tray 30 and reinforce the rigidity of the upper end of the tray 30. Therefore, the front and rear sides 314 and the upper end rim 315 are integrated to constitute a secure structure.

Meanwhile, a height of the outer peripheral frame 310 is larger than a height of the accommodated battery 10 so that a bottom surface 316 of the upper end tray 30 does not come into contact with the battery 10 accommodated in the lower end tray 30 even though the trays 30 are stacked and used. To this end, a predetermined space needs to be ensured above the accommodated battery 10. Therefore, for example, the design needs to be made so that the upper end of the accommodated battery 10 is approximately coincident with the lower end of the upper end rim 315 of the outer peripheral frame 310 within a limit in which the height of the tray 30 does not excessively increase.

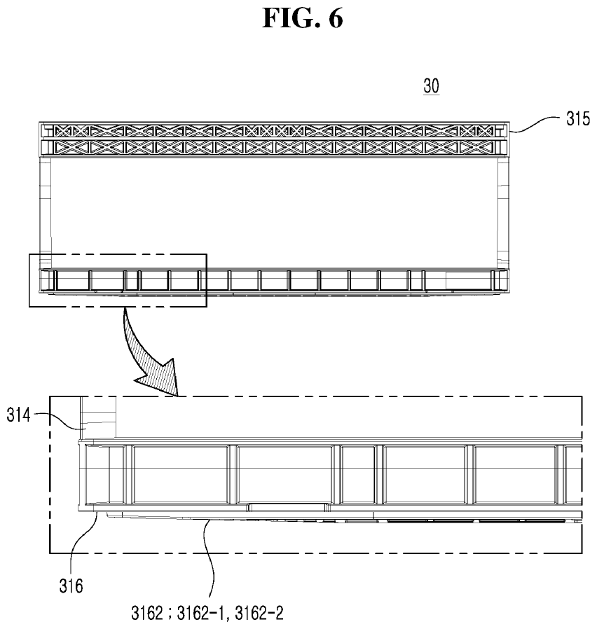

With reference to FIG. 6, one of the features of the present disclosure is that a means capable of minimizing vibration or noise, which may occur during a process of conveying the tray 30 by using a roller conveyor 40, is provided as a shape element for the tray 30. The means or the shape elements are tapered portions 3162 provided on the bottom surface 316 of the outer peripheral frame 310. The tapered portion 3162 is shaped to become thinner outward from a center of the bottom surface 316 of the outer peripheral frame 310, i.e., in a direction toward a peripheral edge portion of the bottom surface 316 of the outer peripheral frame 310.

Specifically, with reference to FIG. 7, a height deviation occurs between the center and the edge of the outer peripheral frame 310 because of the tapered portion 3162, such that the edge of the bottom surface 316 of the moving tray 30 enters the conveyor 40 at a position higher than a front roller of the conveyor 40. Therefore, the tapered portion 3162 comes into contact with the front roller of the conveyor 40 as if the tapered portion 3162 softly and sequentially lands on the front roller, such that noise and vibration are minimized. Further, even though the roller conveyor 40 locally sags because of a load of the stacked the trays 30, the artificial height deviation implemented between the central portion and the peripheral edge portion of the bottom surface 316 of the tray 30 by the tapered portion 3162 may compensate for the local sagging, thereby minimizing noise and vibration caused by a collision between the front roller and the edge of the bottom surface 316 of the tray 30. In order to perform this operation, an extension direction of the tapered portion 3162 is designed as a direction parallel to a conveyance direction of the roller conveyor 40.

Selectively, a group of the tapered portions 3162 having different extension directions may be additionally provided. For example, with reference to FIGS. 8A and 8B, in a state in which first tapered portions 3162-1, which are formed in the direction parallel to the conveyance direction of the roller conveyor 40, are basically provided as one group, second tapered portions 3162-2, which have inclination directions perpendicular to the inclination directions of the first tapered portions 3162-1, may be additionally provided as another group. Like the first tapered portion 3162-1, the second tapered portion 3162-2 has the inclined shape that becomes thinner outward from the center of the bottom surface 316 of the outer peripheral frame 310. As the second tapered portion 3162-2 is selectively provided, the effect of reducing noise and vibration may be expected not only in the extension direction of the first tapered portion 3162-1 but also in the extension direction of the second tapered portion 3162-2. Therefore, the process of aligning the tray 30 to implement the effect of reducing noise and vibration is not complicated, and the working efficiency is improved, in comparison with the case in which the first tapered portion 3162-1 is provided.

With reference to FIGS. 3 and 5, another of the features of the present disclosure is to provide a means for preventing heat, which is generated during the process of charging or discharging the battery 10, from remaining in an internal space of the tray 30. This means is particularly useful when the trays 30 are stacked and used. That is, in case that the trays 30 are stacked, a space disposed above the battery 10 accommodated in the lower end tray 30 is sealed by the upper end rim 315 of the lower end tray 30 and the bottom surface 316 of the upper end tray 30. For this reason, heat, which is generated during the process of charging or discharging the battery 10 accommodated in the lower end tray 30, is trapped in the internal space disposed above the lower end tray 30, and it is not easy to dissipate the heat to the outside. Therefore, the present disclosure is characterized in that heat dissipation ports 3152 are provided inside and outside sidewalls of the outer peripheral frame 310 to prevent the occurrence of residual heat.

In particular, because an upper space of the stacked lower end tray 30 needs to communicate with outside air in a horizontal direction, the heat dissipation port 3152 may be formed at an uppermost end of each of the sidewalls of the outer peripheral frame 310, particularly formed in a lateral portion of the upper end rim 315. In the embodiment, the heat dissipation port 3152 is formed in a portion of the upper end rim 315 disposed above the front and rear sides 314 of the outer peripheral frame 310. Therefore, the heat, which is generated from the accommodated battery 10, may be moved upward, collected, and then smoothly dissipated to the outside through the heat dissipation port 3152, thereby suppressing the occurrence of residual heat to a minimum level.

According to the present disclosure described above, the tapered portions 3162 formed in the bottom surface 316 of the lateral sides 314 may minimize vibration or noise caused by the collision between the roller and the bottom surface 316 of the battery carrying tray 30 during the conveyance process regardless of the presence or absence of the height deviation in the conveyance direction of the conveyor. In addition, the plurality of heat dissipation ports 3152 formed at the uppermost ends of the sidewalls of the battery carrying tray 30 minimizes the amount of heat remaining in the battery carrying tray 30. Therefore, it is possible to remarkably improve product yields, performance, process efficiency, and working environments.

What is claimed is:

1. A battery carrying tray comprising:
an outer peripheral frame; and
a plurality of inserts having a plurality of slots into which battery leads are inserted and supported, the plurality of inserts being detachably coupled to the outer peripheral frame,
wherein a tapered portion is provided on a bottom surface of the outer peripheral frame and shaped to become thinner outward from a center of the bottom surface of the outer peripheral frame.

2. The battery carrying tray of claim 1, wherein the tapered portion is configured as a first tapered portion having an inclination direction parallel to a conveyance direction of an external roller conveyor.

3. The battery carrying tray of claim 2, wherein the tapered portion further comprises a second tapered portion having an inclination direction perpendicular to the first tapered portion.

4. The battery carrying tray of claim 1, wherein a plurality of heat dissipation ports is provided in sidewalls of the outer peripheral frame and configured to allow the inside and outside of the sidewalls to communicate with each other.

5. The battery carrying tray of claim 4, wherein the heat dissipation port is formed at an uppermost end of each of the sidewalls and communicates with a space disposed above a battery accommodated in the battery carrying tray.
